(19) United States
(12) Patent Application Publication
(10) Pub. No.: US 2014/0157652 A1
(43) Pub. Date: Jun. 12, 2014

(54) Removable Fishing Bead

(71) Applicant: Larry Alfred Fiori, Kennebunk, ME (US)

(72) Inventor: Larry Alfred Fiori, Kennebunk, ME (US)

(21) Appl. No.: 13/971,119

(22) Filed: Aug. 20, 2013

Related U.S. Application Data
(60) Provisional application No. 61/742,788, filed on Aug. 20, 2012.

(51) Int. Cl. A01K 85/00; A01K 97/00

(52) U.S. Cl. CPC A01K 85/005; A01K 97/00
USPC 43/44.91; 43/44.93; 264/219

(57) ABSTRACT

An improved bead (10), for use on a string or a line (13), that allows addition to or removal from the string transversely rather than axially, obviating the task of threading the bead with the string. Such a bead finds great benefit when used as a fishing bead, sinker or float, but may be found useful in many other applications.

### CROSS-REFERENCE TO RELATED APPLICATIONS

This Application claims the benefit of Provisional Patent Application Ser. No. 61/742,788 filed 2012 Aug. 20 by the present Inventor.

### FEDERALLY SPONSORED RESEARCH

Not applicable

### SEQUENCE LISTING OR PROGRAM

Not applicable

### BACKGROUND OF THE INVENTION

Beads that remain permanently on a string have long been known, but in certain applications, such as fishing, it becomes necessary to frequently move, add or remove beads from along their string, for example to add weights or a float to the line. In this case, a slot in the bead allows the bead to be removed and inserted transversely to the string rather than along it.

### PRIOR ART

U.S. Pat. No. 2,001,241 to De Vries (1934) discloses such a bead and discusses its benefits; De Vries '241 comprises six component parts. U.S. Pat. No. 3,069,802 to Olsen (1962) and U.S. Pat. No. 3,192,662 to Hoyle (1965) disclose other attempts to incorporate this functionality.

U.S. Pat. No. 4,615,136 to Bank (1985) and U.S. Pat. No. 7,162,830 to Sims (2007) improve on De Vries '241 by using only two separate component parts, and U.S. Pat. No. 7,805,881 to Kavanaugh (2010) discloses a single-component self-hinged device that closes over one string but also can be optionally equipped to close over a plurality of strings or to lock in position along these strings. International Patent WO 1998/018316 discloses a two-component bead that snaps together across two perpendicularly crossing strings to allow a number of hook lines to be attached along a main or drag line.

### SUMMARY OF THE INVENTION

As can be seen, each of these demands a certain amount of careful manual assembly in the field, coordinating several small parts and the strings to which they fasten, often in an icy water and bad weather environment.

The present invention obviates these complex demands by employing novel molding methods and materials to produce a simple, single-piece device that snaps simply and directly over a string or fishing line by itself, stays in position unless deliberately moved and has the advantage of appearing, to a fish, like a tasty fish egg. A further advantage is the ability to add scented attractant materials within the side slot that tend to attract fish through their sense of smell. Yet another is the ability to lock the bead in position using a simple toothpick if it should become necessary. Perhaps the greatest advantage is the simplicity and low cost of manufacture, making this device financially available to a broad spectrum of users.

### DRAWINGS—FIGURES

FIG. 1 is an end view of the bead device, revealing its bore and slot.

FIG. 2 is a perspective view of the bead device placed along a fishing line at a selected location.

FIG. 3 is a perspective view of the bead device, taken from a point where the slot and its contents may be readily seen.

FIG. 4 is a cross-section view taken along the plane indicated by lines 4-4 in FIG. 3.

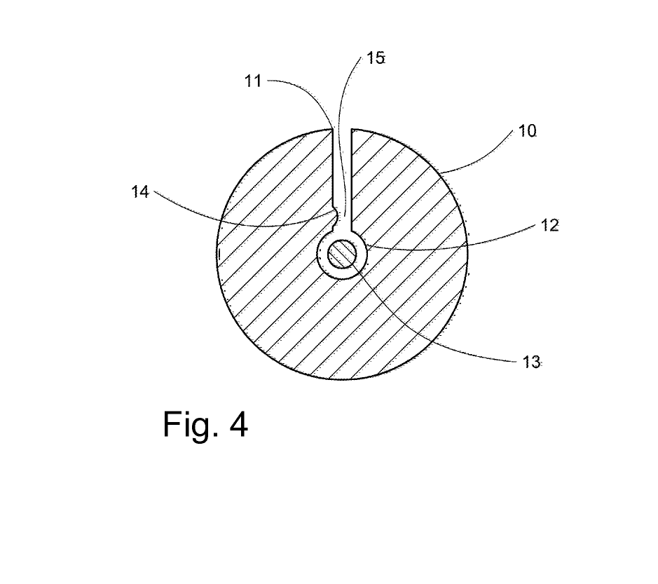

FIG. 5 is a perspective view of the bead device showing added attractant material.

FIG. 6 is a perspective view of the bead device in place on a fishing hook.

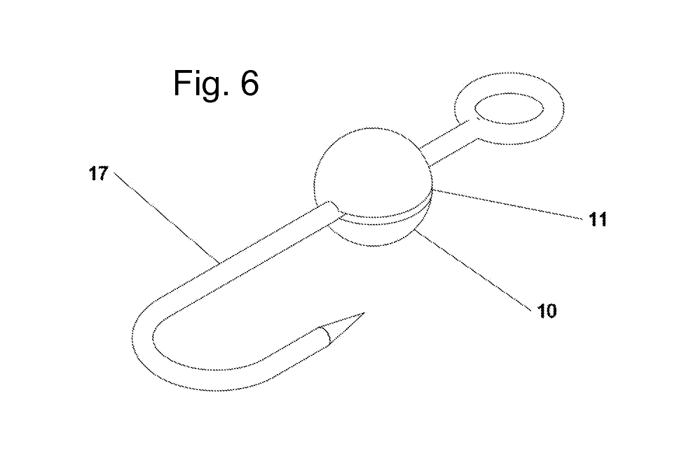

DRAWINGS-REFERENCE NUMBERS

| | |
|---|---|
| 10 | bead |
| 11 | slot |
| 12 | bore |
| 13 | line or string |
| 14 | projection |
| 15 | gap |
| 16 | attractant |
| 17 | fishing hook |

### DETAILED DESCRIPTION OF THE INVENTION

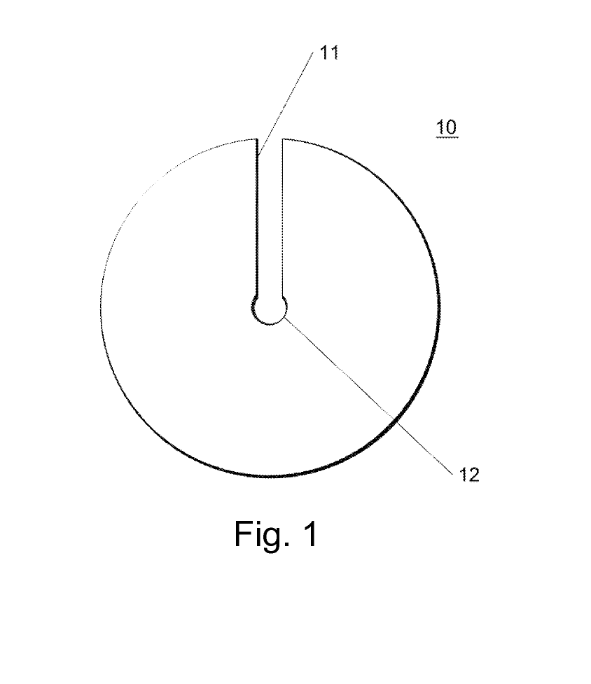

One embodiment of the bead device is best seen in FIG. 1 as item 10, showing the slot 11 into which the line 13 is placed. Slot 11 has a width preferably narrower than the diameter of line 13, such that line 13 must be forced through slot 11 and thence retained in bore 12 by elastic recovery of bead 10′s original shape.

Bead 10 may be selected from a range of sizes, colors and materials, as well as a range of dimensions chosen for a particular fit on lines 13 of particular size and characteristics.

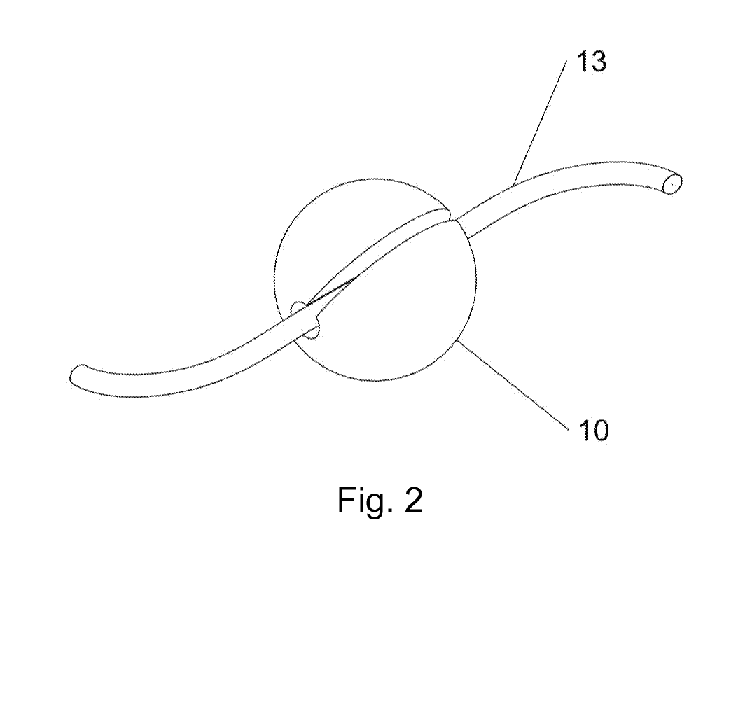

In practice, the user would first decide which particular characteristic of bead should be chosen, and where along the line it should be placed. In one single and simple operation, the line 13 would be drawn into the slot 11, as in FIG. 2, and forced with tension to pass through the slot 11 into the bore 12. Consequently, line 13 is held in place within bore 12 by the combination of elastic forces and circumferential forces.

If one end of the line 13 might be anchored, as when wrapped around a fishing reel for example, then the entire operation of installing the bead 10 could be accomplished using but one hand. More typically, perhaps, line 13 might be free along its length, calling for an extra hand to maintain tension along line 13. In either case, this assembly of the bead 10 to the line 13 is markedly simpler than any known in the prior art.

The elastic forces holding bead 10 in position along line 13 are generally sufficient to withstand sliding displacement by water running past the bead, as in trolling a line, yet they can be overcome by manually forcing the bead 10 along the line 13 for specific adjustment if desired. Such may be desired if several beads are strung together in a lineup of beads to simulate a nest of eggs. Careful design of the shape of bore 12 allows the bead to be removed from the line and reused if desired. In alternative embodiment, this shape of bore 12 may be deliberately chosen to prevent removal, for example by changing the sharpness of any fillet transition between slot 11 and bore 12.

Where for specific reasons it becomes desirable to lock the bead 10 in place along line 13, the tip of a low-cost conventional wooden toothpick may be inserted into bore 12 to jam line 13 in place. After insertion, such a toothpick may be broken off against the edge of bead 10 where bore 12 exits bead 10. Alternatively, a lengthy, taper-shaped fiber may be introduced by its thin end into bore 12 adjacent to line 13 and pulled from the thin end of its taper such that it gradually jams line 13 in place. Subsequently, the free ends of such a wedge may be trimmed at the ends of bore 12 and discarded or left in place to look like vegetable matter. Examples of such wedges are E-Z Pegs and Super E-Z Pegs as currently described on the World Wide Web at <http://www.lazylarrys.com/pegs.php>.

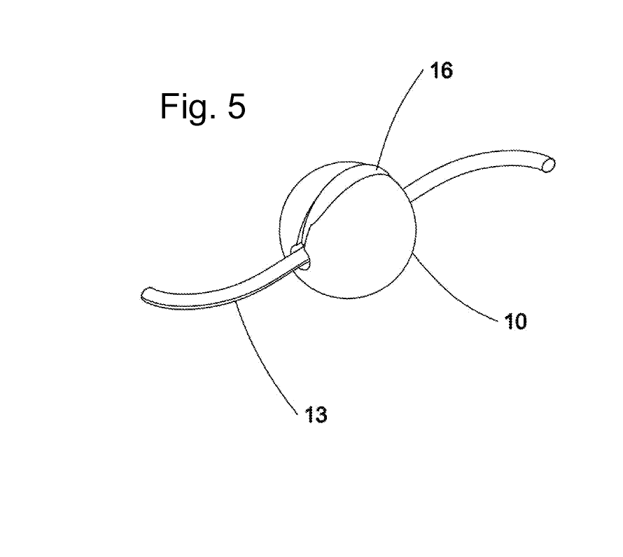

If desired, to improve chances of capturing a fish, a supplemental wax-, cream-, or gel-like attractant material may be smeared into slot 11 after bead 10 is in place, as seen in FIG. 5. Such a material may, for example, exude smells or tastes into the surrounding water, leaving a trail in current or if trolling, or dispersing around the bead if stationary.

Moreover, with beads simulating fish eggs, there is a tendency for the fish to target the bead 10 and not properly engage the fishing hook 17, such that the hook's end snags on the outside of the fish rather than within its mouth. In effect, the bead 10 is swallowed and the fishing hook 17 is not. In fishing terms this is known as being “foul hooked,” and is illegal in some jurisdictions. With the instant invention, the shank of the hook 17 itself may be considered as a line 13, placing the bead 10 directly on, and as a part of, the fishing hook 17, thereby not causing external injury or infection to the fish's body in the frequent case where the fish is released back to the wild.

### Method of Manufacture

To manufacture the invention, economy is paramount. Complex and expensive beads as seen in the prior art may be justifiable in commercial fishing, but may be prohibitively expensive for the casual weekend fisherman. One example of an inexpensive and simple way to manufacture the bead 10 would be by injection molding.

With injection molding, a cavity is created that dimensionally mimics the outside shape of the bead 10, and fluid plastic resin is injected into this cavity to completely fill it. The cavity is provided with a means for opening along a so-called parting line in such a manner as to allow retrieval of the cooled and hardened plastic molded part. By the nature of this invention, it lends itself to extremely inexpensive injection molding wherein the major cost is primarily that of the material itself. No secondary operations need be applied.

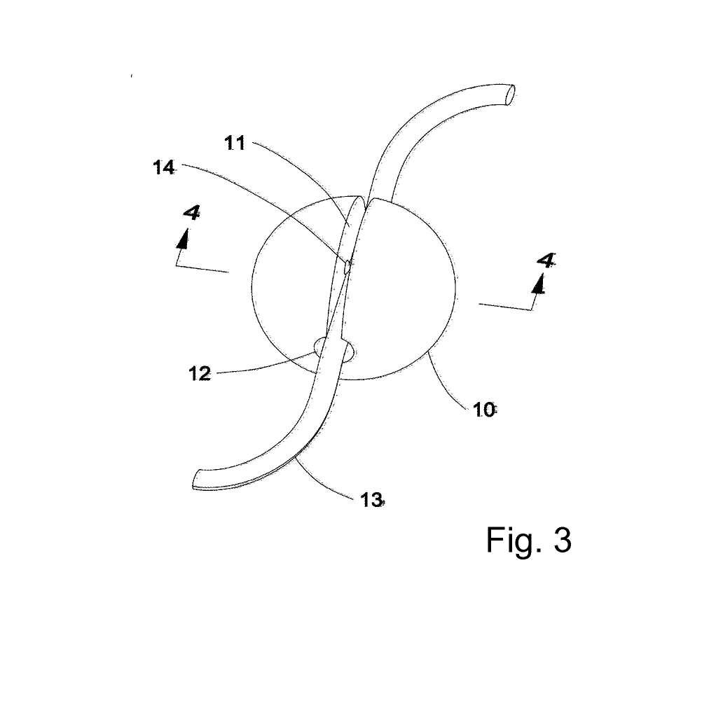

By electing the parting line as being coincident with the plane of section 4-4 as shown in FIG. 3, two identical hemispherical cavities would together define the spherical outside of bead 10, and two symmetrically identical blades, each within one hemisphere and butting tightly together at the plane of 4-4, would together define the sides of slot 11.

With such a simple mold, it would furthermore be trivial to create small, detailed concavities adjacent the tips of each blade that would, taken together, define the shape of a projection 14 formed integrally with the body of bead 10. One example of such a projection 14 is shown in FIG. 3 as a dimple within the slot, but other configurations of concavities could as well produce an annular ring within the bore 12, or even an offset in the axis of bore 12 to help grip the line 13 more firmly.

Such a projection 14 could provide a local point where the slot 11, bore 12 or both are substantially narrowed, as shown at gap 15, past which line 13 need be manually snapped or forced into bore 12 such that line 13 is retained by compression stress impinging against it by projection 14 against bore 12. Alternatively, projection 14 may be shaped to use with a wider slot 11, to allow easy entry of line 13 into slot 11 while also allowing line 13 to freely slide within an enlarged bore 12.

With disclosure of this novel and useful invention, other detail modifications are clearly within the scope of the Claims thereto. One such might be the provision of rounded edges or fillets at various intersections of certain surfaces within the device, for example.

I claim:

1. A bead for use along a string or a line of predetermined cross-section, comprising one unitary solid piece of homogenous elastic material and further comprising:
a. a through bore providing an axial path for said string or line to extend through said bead, said bore having a predetermined cross-sectional area; and
b. a slot coinciding with said bore and extending outwardly through the outer surface of said bead, providing thereby a path for said string or line to be moved sideways into said bore, said slot having a predetermined width
whereby said string or line may be simply inserted into said through bore without the need for threading it endwise.

2. The bead of claim 1 further comprising a projection within said slot, said projection locally narrowing said predetermined width to a predetermined gap, said gap thereby providing an obstacle for said string or line to enter or to leave said bore, and wherein said projection is of a shape selected to relatively facilitate entry of said string or line into said bore and to relatively obstruct removal of said string or line from said bore.

3. The bead of claim 2 wherein said projection is of a shape selected to relatively facilitate entry of said string or line into said bore and to relatively obstruct removal of said string or line from said bore.

4. The bead of claim 2 wherein said projection is of a shape selected to prevent axial movement of said string or line within said bore below a predetermined tensile force.

5. The bead of claim 2 wherein said projection is of a shape selected to permit free axial movement of said string or line within said bore while yet providing an obstacle for removal thereof.

6. The bead of claim 2 wherein said projection is of a shape selected to guide the tip of a toothpick or other selected wedge device into compressive frictional contact against said string or line, thereby locking said bead into a fixed position along said string or line.

7. The bead of claim 2 wherein said slot and said projection are each of a width and a shape respectively selected to affix said bead to the shank of a fishing hook in lieu of said string or line.

8. A method of manufacturing a bead for use along a string or a line of predetermined cross-section, comprising one single solid piece of homogenous elastic material, said process comprising the steps of
a. creating a mold for the shape of said bead, said mold comprising means for defining the outside shape of said bead, the width and shape of said slot and said bore, respectively and the dimensions of said projection;
b. injecting said mold with a material such as a polymer selected to cure into an elastic material with the desired texture, color, tensile strength and elastic strength to serve the purposes of said bead;
c. opening said mold along a parting line that allows free ejection of said finished bead from said mold; and
d. ejecting said finished bead from said mold.
